(19) United States
(12) Patent Application Publication
(10) Pub. No.: US 2022/0100141 A1
(43) Pub. Date: Mar. 31, 2022

(54) IMAGE FORMING APPARATUS

(71) Applicant: FUJIFILM Business Innovation Corp., Tokyo (JP)

(72) Inventors: Kazuki Kuramoto, Kanagawa (JP); Akira Shimodaira, Kanagawa (JP)

(73) Assignee: FUJIFILM Business Innovation Corp., Tokyo (JP)

(21) Appl. No.: 17/225,779

(22) Filed: Apr. 8, 2021

(30) Foreign Application Priority Data
Sep. 30, 2020 (JP) 2020-164290

(51) Int. Cl. G03G 21/08; G03G 15/16

(52) U.S. Cl. CPC G03G 21/08; G03G 15/1675

(57) ABSTRACT

An image forming apparatus includes: an image bearing member that has a toner image formed thereon while rotating and that retains the toner image until the toner image is transferred; a charging unit that receives an image-formation charge voltage having a predetermined first polarity and used for electrostatically charging the image bearing member; an exposure unit that radiates exposure light onto a region of the image bearing member so as to form an electrostatic latent image on the image bearing member, the region of the image bearing member receiving the image-formation charge voltage applied by the charging unit; a developing unit that uses a toner to develop the electrostatic latent image formed on the image bearing member by the exposure unit; a transfer unit that nips a transfer member by working together with the image bearing member and that receives a transfer voltage having a second polarity opposite to the first polarity between the transfer unit and the image bearing member so as to transfer the toner image formed on the image bearing member by the developing unit onto the transfer member; and a controller that causes a transfer-unit static-elimination voltage to be applied to the transfer unit and causes a static-elimination charge voltage to be applied to the charging unit in an image-formation terminating sequence, the transfer-unit static-elimination voltage having the second polarity and having an absolute value larger than the transfer voltage, the static-elimination charge voltage having the first polarity and having an absolute value smaller than the image-formation charge voltage.

### CROSS-REFERENCE TO RELATED APPLICATIONS

This application is based on and claims priority under 35 USC 119 from Japanese Patent Application No. 2020-164290 filed Sep. 30, 2020.

### BACKGROUND

### (i) Technical Field

The present disclosure relates to image forming apparatuses.

### (ii) Related Art

A known so-called electrophotographic image forming apparatus includes an image bearing member that receives a toner image formed thereon while rotating and that retains the toner image until the toner image is transferred. In the case of such an image forming apparatus, the image bearing member is electrostatically charged for forming an electrostatic latent image thereon during an image forming process. If the image bearing member remains in the electrostatically charged state until the end of the image forming process, an image defect caused by toner fog or carrier transfer to the image bearing member (simply referred to as “carrier transfer” hereinafter) may possibly occur. Therefore, when the image forming process ends, the electrostatic charge is eliminated from the image bearing member before the image bearing member is stopped from rotating.

Japanese Unexamined Patent Application Publication No. 2015-028604 proposes an example involving eliminating the electrostatic charge from the surface of the image bearing member by emitting light from an exposure unit when a rotating member is to be stopped, and then further eliminating the electrostatic charge from the surface of the image bearing member at a transfer electric field.

Moreover, Japanese Unexamined Patent Application Publication No. 2001-350385 proposes an example of a technology for preventing toner fog and carrier transfer by keeping the surface potential of a photoconductor and the development potential constant.

### SUMMARY

Aspects of non-limiting embodiments of the present disclosure relate to an image forming apparatus that may eliminate electrostatic charge of an image bearing member to a predetermined electric potential without having to actuate a static elimination lamp or an exposure unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: an image bearing member that has a toner image formed thereon while rotating and that retains the toner image until the toner image is transferred; a charging unit that receives an image-formation charge voltage having a predetermined first polarity and used for electrostatically charging the image bearing member; an exposure unit that radiates exposure light onto a region of the image bearing member so as to form an electrostatic latent image on the image bearing member, the region of the image bearing member receiving the image-formation charge voltage applied by the charging unit; a developing unit that uses a toner to develop the electrostatic latent image formed on the image bearing member by the exposure unit; a transfer unit that nips a transfer member by working together with the image bearing member and that receives a transfer voltage having a second polarity opposite to the first polarity between the transfer unit and the image bearing member so as to transfer the toner image formed on the image bearing member by the developing unit onto the transfer member; and a controller that causes a transfer-unit static-elimination voltage to be applied to the transfer unit and causes a static-elimination charge voltage to be applied to the charging unit in an image-formation terminating sequence, the transfer-unit static-elimination voltage having the second polarity and having an absolute value larger than the transfer voltage, the static-elimination charge voltage having the first polarity and having an absolute value smaller than the image-formation charge voltage.

### BRIEF DESCRIPTION OF THE DRAWINGS

An exemplary embodiment of the present disclosure will be described in detail based on the following figures, wherein:

FIG. 1 schematically illustrates an image forming apparatus according to an exemplary embodiment of the present disclosure;

FIG. 2 illustrates one of image forming engines, as well as power sources, motors, and a controller that are related to the characteristic features of this exemplary embodiment;

FIGS. 3A and 3B illustrate a method of eliminating electrostatic charge from an image bearing member by using a transfer unit and an exposure unit;

FIG. 4 schematically illustrates an effective width, in the rotational-axis direction, of each of components disposed around the image bearing member;

FIGS. 5A and 5B illustrate a static elimination process in the image forming apparatus according to this exemplary embodiment;

FIG. 6 illustrates voltages applied to a charging unit and a developing unit and an electric current value flowing to the transfer unit in an example where the static elimination is performed in two separate stages;

FIG. 7 illustrates a flowchart of cycle shutdown operation when the static elimination is performed in two separate stages; and

FIG. 8 illustrates a timing chart of the cycle shutdown operation when the static elimination is performed in two separate stages.

### DETAILED DESCRIPTION

An exemplary embodiment of the present disclosure will be described below.

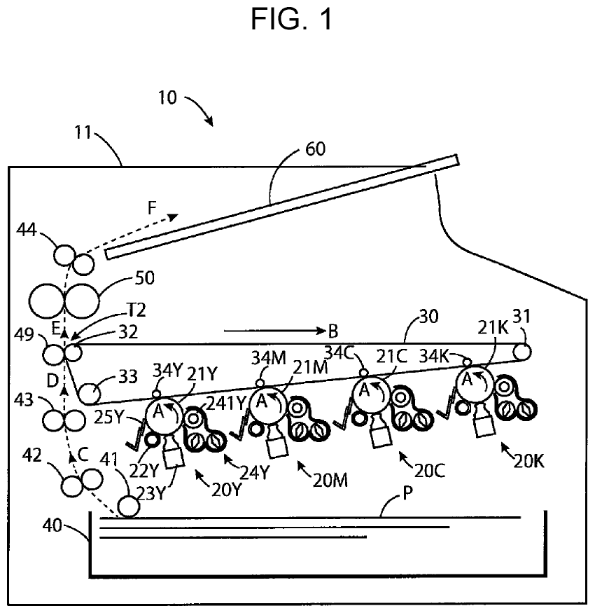

FIG. 1 schematically illustrates an image forming apparatus 10 according to an exemplary embodiment of the present disclosure.

The image forming apparatus 10 has an apparatus housing 11 that contains four image forming engines 20Y, 20M, 20C, and 20K. The characters Y, M, C, and K of the reference signs 20Y, 20M, 20C, and 20K indicate the colors of toners. In the image forming engines 20Y, 20M, 20C, and 20K, toner images are formed using toners of Y, M, C, and K colors, respectively. If it is not necessary to differentiate the colors of the toners from one another and the description is common among the image forming engines 20Y, 20M, 20C, and 20K, the characters Y, M, C, and K for differentiating the colors of the toners from one another will be omitted, such that the image forming engines 20Y, 20M, 20C, and 20K will be expressed as image forming engines 20. The same applies to other components.

Each image forming engine 20 includes an image bearing member 21. The image bearing member 21 is surrounded by a charging unit 22, an exposure unit 23, a developing unit 24, and a cleaning unit 25. The image bearing member 21 receives the effects of the charging unit 22, the exposure unit 23, the developing unit 24, and the cleaning unit 25 while rotating in the direction of an arrow A.

The charging unit 22 electrostatically charges the image bearing member 21. The charging unit 22 according to this exemplary embodiment is a contact-type charging unit that electrostatically charges the image bearing member 21 while being in contact with the image bearing member 21.

The exposure unit 23 radiates exposure light onto the image bearing member 21 so as to form an electrostatic latent image thereon. The exposure unit 23 according to this exemplary embodiment is of a type that has multiple light emitting elements arranged along a rotational axis of the image bearing member 21 and that exposes the image bearing member 21 to light emitted by the light emitting elements.

The developing unit 24 develops the electrostatic latent image on the image bearing member 21 by using a toner. The developing unit 24 is of a type that accommodates a developer containing a toner and a carrier and that uses a developing roller 241 to transport the accommodated developer to a position facing the image bearing member 21 so as to develop the electrostatic latent image by using the toner contained in the developer. A toner image formed as a result of the developing process is transferred onto an intermediate transfer belt 30, to be described later.

The toner remaining on the image bearing member 21 after the transfer process is removed therefrom by the cleaning unit 25.

The image bearing member 21, the charging unit 22, the exposure unit 23, the developing unit 24, and a transfer unit 34 respectively correspond to examples of an image bearing member, a charging unit, an exposure unit, a developing unit, and a transfer unit according to an exemplary embodiment of the present disclosure. Furthermore, the intermediate transfer belt 30 corresponds to an example of a transfer member according to an exemplary embodiment of the present disclosure.

In the apparatus housing 11, the intermediate transfer belt 30 is provided directly above the image forming engines 20. The intermediate transfer belt 30 is wrapped around multiple rollers 31 to 33 and circulates in the direction of an arrow B along a path extending along the image bearing members 21. The transfer units 34 are disposed within the intermediate transfer belt 30 at positions facing the image bearing members 21 with the intermediate transfer belt 30 interposed therebetween. The transfer units 34 transfer the toner images formed on the image bearing members 21 onto the intermediate transfer belt 30 such that the toner images are sequentially superposed one on top of another as the intermediate transfer belt 30 circulates. The toner images transferred on the intermediate transfer belt 30 are further transported to a second-transfer position T2.

A sheet tray 40 is provided at a lower section in the apparatus housing 11. The sheet tray 40 contains a stack of sheets P that have not undergone an image forming process yet. When an image forming process is to be performed, one of the sheets P is fetched from the sheet tray 40 by a pickup roller 41 and is transported in the direction of an arrow C by a transport roller 42 until the leading edge of the sheet P reaches a timing adjustment roller 43. Then, the timing adjustment roller 43 delivers the sheet P in the direction of an arrow D such that the sheet P reaches the second-transfer position T2 at a timing at which the toner images on the intermediate transfer belt 30 reach the same second-transfer position T2. At the second-transfer position T2, a second-transfer unit 49 transfers the toner images onto the sheet P.

The sheet P having the toner images transferred thereon is transported in the direction of an arrow E, so as to reach a fixing unit 50. The toner images on the sheet P are fixed onto the sheet P as a result of receiving heat and pressure applied by the fixing unit 50.

The sheet P having an image constituted of the toner images fixed thereon by the fixing unit 50 is delivered in the direction of an arrow F by a delivering roller 44 onto a paper output tray 60 provided at an upper surface of the apparatus housing 11.

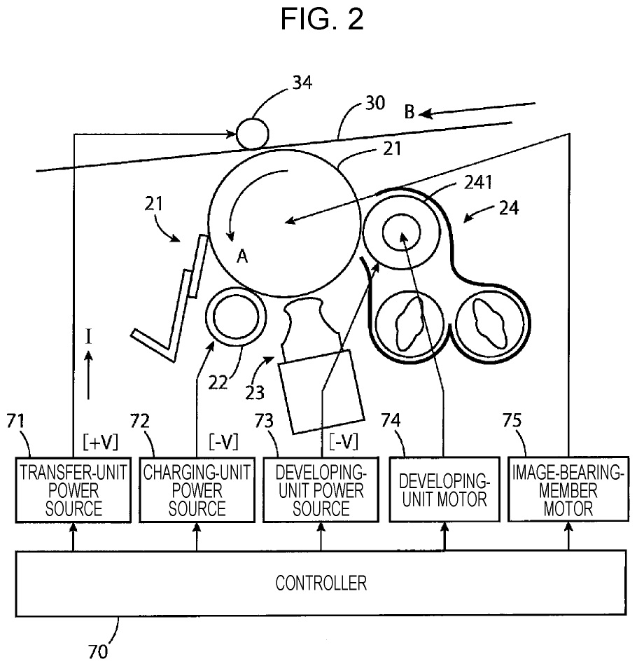

FIG. 2 illustrates one of the image forming engines 20, as well as power sources, motors, and a controller that are related to the characteristic features of this exemplary embodiment.

A transfer-unit power source 71 applies a transfer voltage to the transfer unit 34. The transfer voltage in this case is a voltage with a positive potential. A positive potential corresponds to an example of an electric potential with a second polarity according to an exemplary embodiment of the present disclosure. In this exemplary embodiment, the transfer-unit power source 71 used is a constant-current power source.

A charging-unit power source 72 applies a charge voltage to the charging unit 22. The charge voltage in this case is a voltage with a negative potential. A negative potential corresponds to an example of an electric potential with a first polarity according to an exemplary embodiment of the present disclosure. In this exemplary embodiment, the charging-unit power source 72 used is a constant-voltage power source.

A developing-unit power source 73 applies a development voltage to the developing roller 241. The development voltage is a voltage with the same polarity as the charge voltage, and in this case, is a voltage with a negative potential. The developing roller 241 has a role of transporting a developer containing a toner and a carrier to a position facing the image bearing member 21 while rotating and receiving the development voltage, and developing the electrostatic latent image on the image bearing member 21 by using the toner contained in the developer. In this exemplary embodiment, the developing-unit power source 73 used is a constant-voltage power source similar to the charging-unit power source 72.

A developing-unit motor 74 is a motor that rotates the developing roller 241.

An image-bearing-member motor 75 is a motor that rotates the image bearing member 21.

A controller 70 controls the outputs from the transfer-unit power source 71, the charging-unit power source 72, and the developing-unit power source 73, the on/off modes thereof, and the rotation and stoppage of the developing-unit motor 74 and the image-bearing-member motor 75. Although the controller 70 controls all the components in this exemplary embodiment in addition to the power sources and the motors mentioned above, descriptions thereof will be omitted.

When the image forming process described with reference to FIG. 1 is completed, the image forming apparatus 10 transitions to a shutdown mode or a sleep mode. In order to transition to the shutdown mode or the sleep mode, the image forming apparatus 10 executes an image-formation terminating sequence prior to the transition. In the image-formation terminating sequence, the image bearing members 21 undergo a static elimination process.

In order to eliminate the electrostatic charge from each image bearing member 21, a static elimination lamp is sometimes used. In contrast, the image forming apparatus 10 according to this exemplary embodiment is not equipped with a static elimination lamp. There is also a case where a static elimination lamp provided has insufficient performance or insufficient durability and is thus not used for eliminating the electrostatic charge from each image bearing member 21 in the image-formation terminating sequence. The following description relates to a case where the electrostatic charge is eliminated from each image bearing member 21 without using a static elimination lamp.

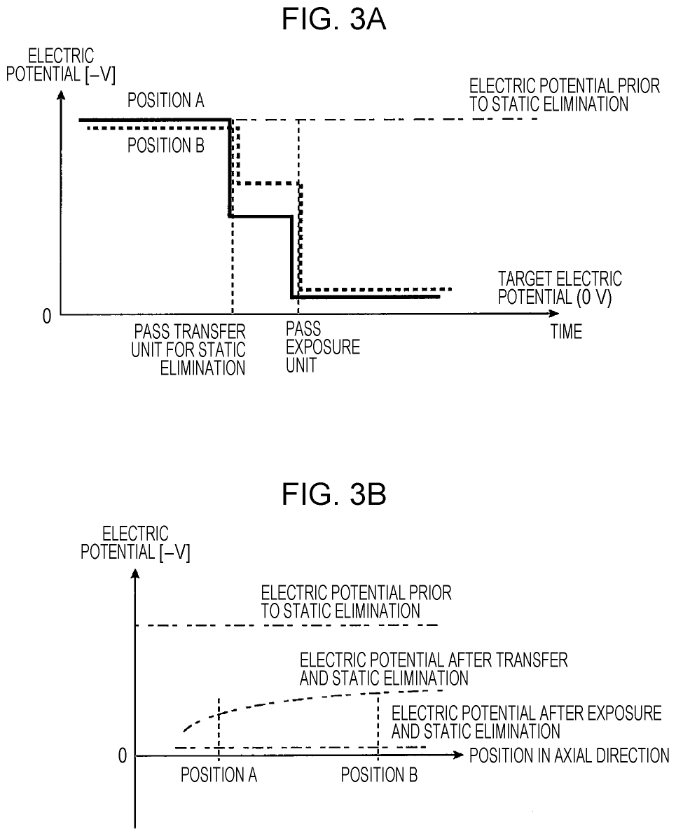

FIGS. 3A and 3B illustrate a method of eliminating electrostatic charge from an image bearing member by using a transfer unit and an exposure unit. The method of eliminating electrostatic charge from an image bearing member by using a transfer unit and an exposure unit shown in FIGS. 3A and 3B is a comparative example compared with the exemplary embodiment of the present disclosure.

FIG. 3A illustrates a temporal change in the charge potential caused by static elimination. Specifically, when the surface of the image bearing member 21 having an electric potential prior to the static elimination passes the position of the transfer unit 34 in accordance with rotation of the image bearing member 21 in the direction of the arrow A, a transfer current flows through the transfer unit 34 in the static elimination direction, so that the electric potential changes by one level toward the static elimination side. Moreover, the image bearing member 21 is reduced in electrostatic charge to a target electric potential as a result of receiving exposure light for static elimination radiated by the exposure unit 23, thereby causing a change in the charge potential of the image bearing member 21.

As shown in FIG. 3B, a position A and a position B are different from each other in the rotational-axis direction of the image bearing member 21. The image bearing member 21 has an electric potential distribution in the rotational-axis direction shown in FIG. 3B when passing the position of the transfer unit 34, but reaches a substantially-uniform target electric potential as a result of being exposed to light by the exposure unit 23. When this static elimination favorably functions over the entire image bearing member 21, a static elimination process without the use of a static elimination lamp is realized.

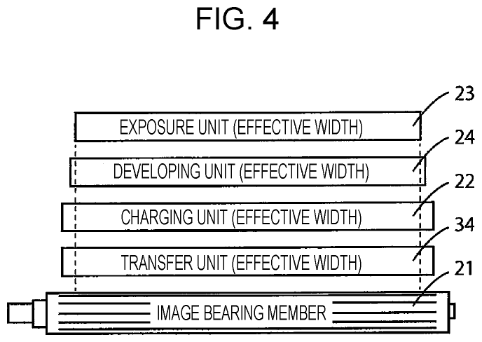

FIG. 4 schematically illustrates an effective width, in the rotational-axis direction, of each of the components disposed around the image bearing member 21.

In this case, the effective width of each of the transfer unit 34, the charging unit 22, the developing unit 24, and the exposure unit 23 is shown.

The transfer unit 34 is set to have a large effective width so that, even when the transfer unit 34 has play in the rotational-axis direction or has a large mounting tolerance, the transferring of the toner image formed on the image bearing member 21 is satisfactorily performed to the widthwise ends.

The charging unit 22 is also set to have a large effective width so that, even when the charging unit 22 has play in the rotational-axis direction or has a large mounting tolerance, the electrostatic charging process is satisfactorily performed to the widthwise ends for forming an electrostatic latent image on the image bearing member 21.

The developing unit 24 is also set to have a large effective width so that, even when the developing unit 24 has play in the rotational-axis direction or has a large mounting tolerance, the electrostatic latent image formed on the image bearing member 21 is satisfactorily developed to the widthwise ends by using a toner.

In contrast, supposing that the exposure unit 23 has play in the rotational-axis direction, the image to be ultimately formed on a sheet may possibly be misaligned in the width direction or may possibly have a missing end in the width direction. Therefore, the mounting accuracy of the exposure unit 23 in the width direction is strictly regulated, and play is also strictly regulated. Specifically, in order to form an electrostatic latent image, the exposure unit 23 may simply have a width equal to or slightly larger than the sheet width. Because this exposure unit 23 is a very high-precision component, an exposure unit 23 with a large effective width may possibly lead to an increase in cost.

An exposure unit 23 that is sufficient for forming an electrostatic latent image but not having an extra effective width will be considered. As shown in FIG. 4, the effective width of the exposure unit 23 is smaller than that of the developing unit 24. The following relates to a conceivable case where the exposure unit 23 having an effective width smaller than that of the developing unit 24 is used for the static elimination described with reference to FIGS. 3A and 3B. In the case of the static elimination described with reference to FIGS. 3A and 3B, the electrostatic charge is eliminated to the target electric potential within the effective width of the exposure unit 23, but remains at the ends protruding from the range of the effective width. In other words, because the effective width of the developing unit 24 is larger than the effective width of the exposure unit 23, the opposite ends of the developing unit 24 face the surface of the image bearing member 21 from which the electrostatic charge is not sufficiently eliminated, that is, the surface of the image bearing member 21 still having the electrostatic charge remaining therein. This implies that, during the image-formation terminating sequence including the static elimination or when the operation is to be resumed for the image forming process, this residual electrostatic charge may cause the toner or the carrier to transfer onto the image bearing member 21, move into the range of the sheet width, and contaminate the sheet, or may possibly cause an image defect to occur at the edges of the sheet.

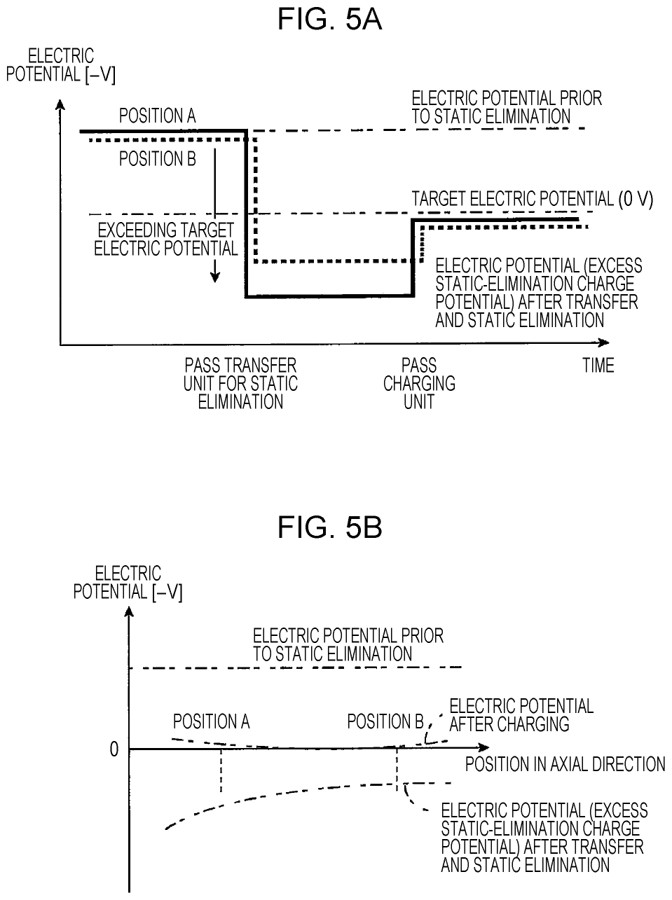

FIGS. 5A and 5B illustrate a static elimination process in the image forming apparatus 10 according to this exemplary embodiment.

FIG. 5A illustrates a change in the charge potential of the image bearing member 21 caused by static elimination. In this case, a static-elimination voltage is applied to the transfer unit 34 such that a static-elimination current flows thereto. The static-elimination current is larger than the transfer current flowing through the transfer unit 34 as a result of applying a transfer voltage thereto during a toner-image transfer process. The transfer-unit power source 71 shown in FIG. 2 has a large current-carrying capacity and may apply a static-elimination current that reduces the image bearing member 21 having an electric potential prior to the static elimination to an excess static-elimination charge potential exceeding a target electric potential. By applying this static-elimination current, the image bearing member 21 is reduced to the excess static-elimination charge potential exceeding the target electric potential. After the image bearing member 21 is reduced to the excess static-elimination charge potential, the charging unit 22 receives a static-elimination charge voltage for setting the surface having the excess static-elimination charge potential back to the target electric potential for the static elimination, whereby the surface having the excess static-elimination charge potential is set back to the target static-elimination charge potential for the static elimination.

When the transfer unit 34 causes the image bearing member 21 to transition from the charge potential to the excess static-elimination charge potential, the image bearing member 21 has an electric potential distribution in the rotational-axis direction shown in FIG. 5B, but subsequently reaches a substantially-uniform target electric potential as a result of being electrostatically charged by the charging unit 22. In addition, since it is clear from FIG. 4 that the effective width of the charging unit 22 is larger than the effective width of the developing unit 24, the image bearing member 21 has the target electric potential over the entire effective width of the developing unit 24. Consequently, the aforementioned problems, such as the possibility of contamination of the sheet occurring due to the toner transferring onto the image bearing member 21 or the possibility of an image defect occurring due to the carrier transferring onto the image bearing member 21, may be suppressed.

In the sequence shown in FIGS. 5A and 5B, it is assumed that the electric potential of the image bearing member 21 transitions to the ultimate target static-elimination charge potential at once while the image bearing member 21 makes one rotation. If the transfer unit 34 has sufficiently high charging performance (static elimination performance) with respect to the image bearing member 21, the sequence shown in FIGS. 5A and 5B in which the electric potential of the image bearing member 21 transitions to the ultimate target static-elimination charge potential at once may be employed. However, if the charging performance (static elimination performance) of the transfer unit 34 is limited, that is, if the transfer-unit power source 71 shown in FIG. 2 does not have enough ability to apply an electric current to the transfer unit 34 for causing a transition from the image-formation charge potential to the excess static-elimination charge potential, which greatly differs from the charge potential, at once, a sequence to be descried below may be employed. Specifically, this sequence involves rotating the image bearing member 21 multiple times and gradually eliminating the electrostatic charge therefrom during each rotation.

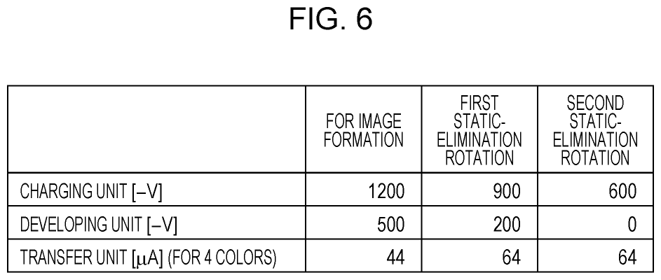

FIG. 6 illustrates voltages applied to the charging unit 22 and the developing unit 24 and an electric current value flowing to the transfer unit 34 in an example where the static elimination is performed in two separate stages.

Although the positive and negative signs for each voltage (potential) will be omitted in the following description, the charging unit 22 and the developing unit 24 in the example to be described below receive a negative voltage [−V], and the transfer unit 34 receives a positive voltage [+V] such that an electric current I (see FIG. 2) flows in the direction for canceling out the negative charge of the image bearing member 21. A negative voltage or potential in this exemplary embodiment corresponds to an example of a first polarity according to an exemplary embodiment of the present disclosure. A positive voltage or potential in this exemplary embodiment corresponds to an example of a second polarity according to an exemplary embodiment of the present disclosure.

In the example shown in FIG. 6, during an image forming process, that is, during a cycle involving forming a toner image and transferring and fixing the toner image onto a sheet, the charging unit 22 receives a voltage of 1200 V. In this case, a discharge start voltage Va of the charging unit 22 is set to 600 V. A discharge start voltage refers to a voltage at which the charging unit 22 starts discharging when the voltage applied to the charging unit 22 is gradually increased from a low voltage, and a remaining voltage obtained after subtraction of the discharge start voltage Va contributes to charging of the image bearing member 21. Therefore, when a voltage of 1200 V is applied to the charging unit 22, the image bearing member 21 is electrostatically charged by a remaining voltage of 600 V obtained by subtracting the discharge start voltage Va of 600 V from the voltage of 1200 V applied to the charging unit 22. The voltage (i.e., 1200 V in this example) applied to the charging unit 22 during the image forming process corresponds to an example of an image-formation charge voltage according to an exemplary embodiment of the present disclosure. Furthermore, the electric potential (i.e., 600 V in this example) of the image bearing member 21 electrostatically charged as a result of the image-formation charge voltage being applied to the charging unit 22 during the image forming process corresponds to an example of an image-formation charge potential according to an exemplary embodiment of the present disclosure.

Furthermore, in the example in FIG. 6, the developing unit 24, specifically, the developing roller 241 of the developing unit 24, receives a voltage of 500 V during the image forming process. This voltage of 500 V is a value lower than the image-formation charge potential of 600 V of the image bearing member 21 by 100 V. Toner fog may be suppressed by this potential difference of 100 V. The potential difference of 100V is also maintained during the first rotation of the static elimination, to be described later. The voltage of 500 V applied to the developing roller 241 of the developing unit 24 during the image forming process corresponds to an example of an image-formation development voltage according to an exemplary embodiment of the present disclosure.

Furthermore, the transfer unit 34 receives a transfer voltage such that a transfer current of 44 μA flows thereto. In the case of the exemplary embodiment described here, the transfer-unit power source 71 shown in FIG. 2 is a single power source shared among the four transfer units 34Y, 34M, 34C, and 34K shown in FIG. 1, and supplies electric power in a parallel fashion to the four transfer units 34Y, 34M, 34C, and 34K. In FIG. 6, a total electric current value flowing to the four transfer units 34Y, 34M, 34C, and 34K is indicated. The electric current of 44 μA during the image forming process corresponds to an example of a transfer current according to an exemplary embodiment of the present disclosure. Furthermore, a voltage applied to the transfer unit 34 during the image forming process for generating the transfer current corresponds to an example of a transfer voltage according to an exemplary embodiment of the present disclosure.

In the example described here, the static elimination is performed in two separate stages, namely, a first stage corresponding to “first static-elimination rotation” and a second stage corresponding to “second static-elimination rotation”.

In the first static-elimination rotation as the first stage of the static elimination, the charging unit 22 receives a voltage of 900 V. Then, the image bearing member 21 is electrostatically charged to a remaining voltage of 300 V obtained by subtracting the discharge start voltage Va of 600 V from 900 V. Regardless of the first rotation or the second rotation, a voltage (i.e., 900 V in the example of the first rotation) applied to the charging unit 22 during the static elimination corresponds to an example of a static-elimination charge voltage according to an exemplary embodiment of the present disclosure. Furthermore, regardless of the first rotation or the second rotation, an electric potential (i.e., 300 V in the example of the first rotation) of the image bearing member 21 electrostatically charged as a result of the static-elimination charge voltage being applied to the charging unit 22 during the static elimination corresponds to an example of a static-elimination charge potential according to an exemplary embodiment of the present disclosure. When the first rotation and the second rotation are to be distinguished from each other, the static-elimination charge voltage applied to the charging unit 22 in the first static-elimination rotation corresponds to an example of a first static-elimination charge voltage according to an exemplary embodiment of the present disclosure. Furthermore, when the first rotation and the second rotation are distinguished from each other, the static-elimination charge potential of the electrostatically-charged image bearing member 21 in the first static-elimination rotation corresponds to an example of a first static-elimination charge potential according to an exemplary embodiment of the present disclosure.

In the first static-elimination rotation, the developing unit 24 receives a voltage of 200 V. As mentioned above, this voltage of 200 V is a value lower than the static-elimination charge potential of 300 V in the first rotation of the image bearing member 21 by 100 V. Toner fog may be suppressed by this potential difference of 100 V. Regardless of the first rotation or the second rotation, a voltage applied to the developing unit 24 during the static elimination corresponds to an example of a static-elimination development voltage according to an exemplary embodiment of the present disclosure. When the first rotation and the second rotation are distinguished from each other, a static-elimination development voltage applied to the developing unit 24 in the first static-elimination rotation corresponds to an example of a first static-elimination development voltage according to an exemplary embodiment of the present disclosure.

Furthermore, in the first static-elimination rotation, each transfer unit 34 receives a voltage such that a total electric current of 64 μA flows to the four transfer units 34Y, 34M, 34C, and 34K. Regardless of the first rotation or the second rotation, an electric current (i.e., an electric current of 64 μA in the example of the first rotation) during the static elimination corresponds to an example of a static-elimination current according to an exemplary embodiment of the present disclosure. Furthermore, regardless of the first rotation or the second rotation, a voltage applied to the transfer unit 34 during the static elimination for generating the static-elimination current corresponds to an example of a transfer-unit static-elimination voltage according to an exemplary embodiment of the present disclosure.

In the case of the exemplary embodiment described here, the total static-elimination current of 64 μA applied to the four transfer units 34 corresponds to a substantially maximum current-carrying capacity of the transfer-unit power source 71, such that the transfer-unit power source 71 is not able to apply an electric current larger than this. On the other hand, with this static-elimination current of 64 μA, it may be not possible to reduce the image-formation charge potential of 600 V of the image bearing member 21 to the ultimate target excess static-elimination charge potential (see FIGS. 5A and 5B) at once. Thus, in the first stage, the charge potential is reduced to a first-stage excess static-elimination charge potential (e.g., 200 V) that is lower than a target charge potential of 300 V in the first stage. Then, in the first stage, the image bearing member 21 that has been reduced to the first-stage excess static-elimination charge potential is adjusted by the charging unit 22 to the target charge potential of 300 V in the first stage.

In the second static-elimination rotation as the second stage of the static elimination, the charging unit 22 receives a voltage of 600 V. Then, the image bearing member 21 is electrostatically charged to a remaining voltage of 0 V obtained by subtracting the discharge start voltage Va of 600 V from 600 V. The static-elimination charge voltage applied to the charging unit 22 in the second static-elimination rotation corresponds to an example of a second static-elimination charge voltage according to an exemplary embodiment of the present disclosure. Furthermore, the static-elimination charge potential of the image bearing member 21 electrostatically charged as a result of the second static-elimination charge voltage being applied to the charging unit 22 in the second static-elimination rotation corresponds to an example of a second static-elimination charge potential according to an exemplary embodiment of the present disclosure.

Furthermore, the developing unit 24 receives a voltage of 0 V in the second static-elimination rotation. The static-elimination development voltage applied to the developing unit 24 in the second static-elimination rotation corresponds to an example of a second static-elimination development voltage according to an exemplary embodiment of the present disclosure.

Furthermore, in the second static-elimination rotation, each transfer unit 34 receives a voltage such that a total electric current of 64 μA flows to the four transfer units 34Y, 34M, 34C, and 34K, similarly to the first static-elimination rotation. However, this is merely an example, and a transfer-unit static-elimination voltage for applying a static-elimination current different from that in the first static-elimination rotation may be used.

Because the charge potential of the image bearing member 21 is reduced to 300 V in the first static-elimination rotation, the charge potential is reduced in the second stage to a second-stage excess static-elimination charge potential (e.g., 100 V with the opposite polarity (i.e., positive polarity in this exemplary embodiment)) that is lower than an ultimate target charge potential of 0 V in the second stage, in accordance with the static-elimination current of 64 μA from the transfer unit 34. Then, in the second stage, the image bearing member 21 that has been reduced to the second-stage excess static-elimination charge potential is adjusted by the charging unit 22 to the ultimate target charge potential of 0 V in the second stage.

Accordingly, electrostatic charge is eliminated from the image bearing member 21 in a stepwise fashion in two separate stages.

In the example shown in FIG. 6, the second static-elimination charge potential and the second static-elimination development voltage are both 0 V, such that the potential difference is zero. If the second static-elimination development voltage becomes higher than the second static-elimination charge potential due to, for example, a voltage setting error, toner fog may possibly occur. Thus, it is also desirable to change the second static-elimination charge voltage of 600 V for the second static-elimination rotation in FIG. 6 to, for example, 630 V, so as to generate a potential difference in which the second static-elimination charge potential is reliably higher than the second static-elimination development voltage. Alternatively, depending on the properties of, for example, the toners and the carriers used in the image forming apparatus 10, the second static-elimination development voltage may be finely adjusted, or both the second static-elimination charge potential and the second static-elimination development voltage may be finely adjusted.

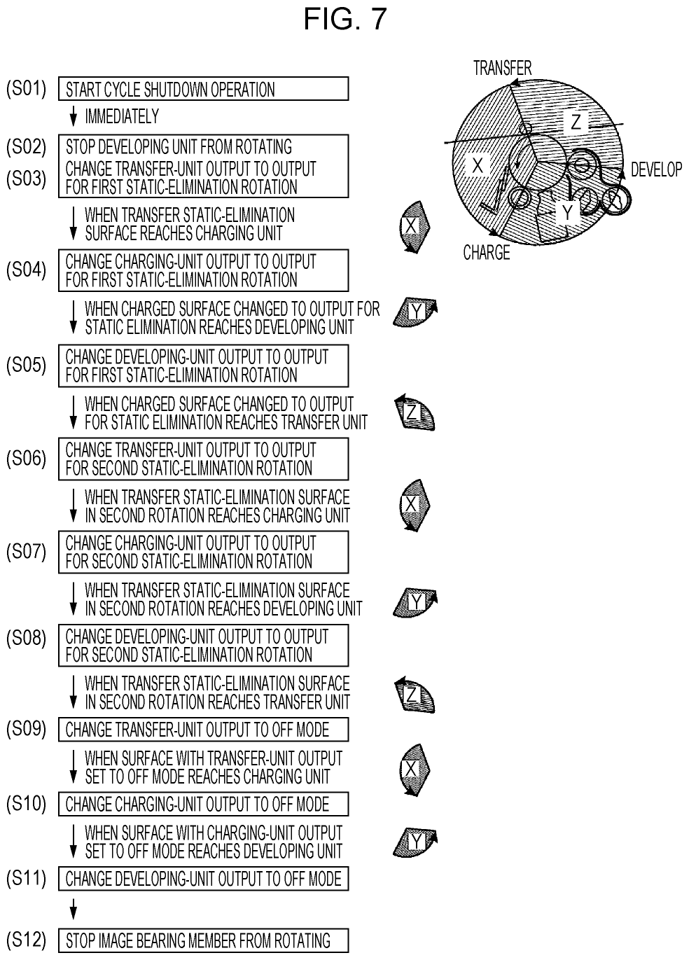

FIG. 7 illustrates a flowchart of cycle shutdown operation when the static elimination is performed in two separate stages. In FIG. 7, one of the image forming engines 20 and the rotation of the image bearing member 21 are also schematically shown.

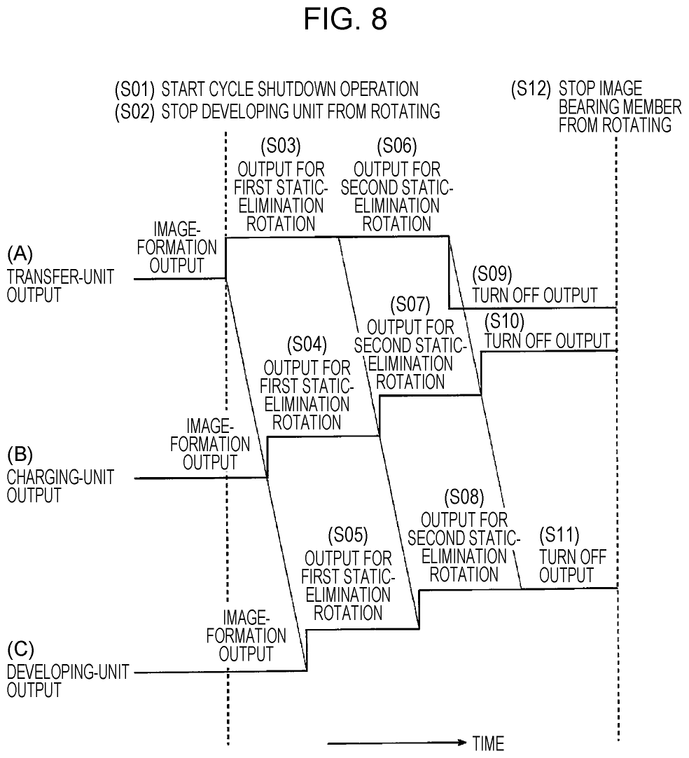

FIG. 8 illustrates a timing chart of the cycle shutdown operation when the static elimination is performed in two separate stages. For better understandability, corresponding sections in the timing chart in FIG. 8 are given the same reference signs as those of steps S01 to S12 in the flowchart in FIG. 7.

Before the cycle shutdown operation shown in FIGS. 7 and 8 starts, a charging-unit output, a developing-unit output, and a transfer-unit output are 1200 V, 500 V, and 44 μA, respectively, shown under the “for image formation” field in FIG. 6. The term “cycle shutdown operation” refers to a cycle in which the operation of the image forming apparatus 10 in an image forming cycle is stopped. This cycle shutdown operation corresponds to an example of an image-formation terminating sequence according to an exemplary embodiment of the present disclosure. The charging-unit output refers to a voltage output from the charging-unit power source 72 shown in FIG. 2 and applied to the charging unit 22. The developing-unit output refers to a voltage output from the developing-unit power source 73 shown in FIG. 2 and applied to the developing unit 24. The transfer-unit output refers to an electric current output from the transfer-unit power source 71 shown in FIG. 2 and is indicated as the total electric current of the four transfer units 34Y, 34M, 34C, and 34K.

When the cycle shutdown operation starts in step S01, the developing unit 24 is stopped from rotating immediately in this example in step S02, and the transfer-unit output is changed to an output for first static-elimination rotation in step S03. In the example shown in FIG. 6, the transfer-unit output is changed to a total electric current of 64 μA of the four transfer units 34Y, 34M, 34C, and 34K.

Subsequently, when the surface of the image bearing member 21 facing the transfer unit 34 at the time of step S03 in which the transfer-unit output is changed to the output for the first static-elimination rotation reaches the charging unit 22, that is, when the image bearing member 21 rotates by an angle corresponding to a region X in the schematic rotation diagram, the charging-unit output is changed to an output for the first static-elimination rotation in step S04. In the example shown in FIG. 6, this charging-unit output is 900 V.

Subsequently, when the surface of the image bearing member 21 facing the charging unit 22 at the time of step S04 in which the charging-unit output is changed to the output for the first static-elimination rotation reaches the developing unit 24, that is, when the image bearing member 21 rotates further by an angle corresponding to a region Y from the region X in the schematic rotation diagram, the developing-unit output is changed to an output for the first static-elimination rotation in step S05. In the example shown in FIG. 6, this developing-unit output is 200 V.

Subsequently, when the surface of the image bearing member 21 facing the developing unit 24 at the time of step S05 in which the developing-unit output is changed to the output for the first static-elimination rotation reaches the transfer unit 34, that is, when the image bearing member 21 rotates further by an angle corresponding to a region Z from the regions X and Y in the schematic rotation diagram so as to make one rotation from the start of the cycle shutdown operation in step S01, the transfer-unit output is changed to an output for second static-elimination rotation in step S06. However, because the transfer-unit output used for the second static-elimination rotation is the same as the static-elimination current of 64 μA for the first static-elimination rotation in the example shown in FIG. 6, the static-elimination current of 64 μA for the first static-elimination rotation is continuously used.

Subsequently, when the surface of the image bearing member 21 facing the transfer unit 34 at the time of step S06 in which the transfer-unit output is changed to the output for the second static-elimination rotation reaches the charging unit 22, that is, when the image bearing member 21 rotates by an angle corresponding to the region X in the schematic rotation diagram in the second rotation, the charging-unit output is changed to an output for the second static-elimination rotation in step S07. In the example shown in FIG. 6, this charging-unit output is 600 V. With this charging-unit output of 600 V, the image bearing member 21 is electrostatically charged to a charge voltage of 0 V.

Subsequently, when the surface of the image bearing member 21 facing the charging unit 22 at the time of step S07 in which the charging-unit output is changed to the output for the second static-elimination rotation reaches the developing unit 24, that is, when the image bearing member 21 rotates further by an angle corresponding to the region Y in the schematic rotation diagram, the developing-unit output is changed to an output for the second static-elimination rotation in step S08. In the example shown in FIG. 6, this developing-unit output is 0 V.

Subsequently, when the surface of the image bearing member 21 facing the developing unit 24 at the time of step S08 in which the developing-unit output is changed to the output for the second static-elimination rotation reaches the transfer unit 34, that is, when the image bearing member 21 rotates further by an angle corresponding to the region Z in the schematic rotation diagram so as to make two rotations from the start of the cycle shutdown operation in step S01, the transfer-unit output is changed to an off mode (i.e., 0 μA) in step S09.

Subsequently, when the surface of the image bearing member 21 facing the transfer unit 34 at the time of step S09 in which the transfer-unit output is changed to the off mode reaches the charging unit 22, that is, when the image bearing member 21 rotates further by an angle corresponding to the region X in the schematic rotation diagram, the charging-unit output is changed to an off mode in step S10.

Subsequently, when the surface of the image bearing member 21 facing the charging unit 22 at the time of step S10 in which the charging-unit output is changed to the off mode reaches the developing unit 24, that is, when the image bearing member 21 rotates further by an angle corresponding to the region Y in the schematic rotation diagram, the developing-unit output is changed to an off mode in step S11. Although the developing-unit output is already 0 V in the second static-elimination rotation in the example shown in FIG. 6, a step (i.e., step S11) for changing the developing-unit output to an off mode is set here in view of the fact that the developing-unit output in the second static-elimination rotation may sometimes undergo fine adjustment.

After the transfer-unit output, the charging-unit output, and the developing-unit output are changed to the off mode in this manner, the image bearing member 21 is stopped from rotating in step S12.

In the sequence of the cycle shutdown operation described above, the developing unit 24 is stopped from rotating in step S02 immediately after the cycle shutdown operation is started. The reason for stopping the developing unit 24 from rotating is that toner fog and carrier transfer may be suppressed more than when the sequence of the cycle shutdown operation is executed while the developing unit 24 continues to rotate. However, from the standpoint of suppressing toner fog and carrier transfer, the developing unit 24 does not necessarily have to be stopped from rotating immediately after the cycle shutdown operation is started, so long as the developing unit 24 is stopped from rotating while the surface of the image bearing member 21 facing the developing unit 24 has the image-formation charge potential (i.e., 600 V in the example shown in FIG. 6 (image-formation charge voltage 1200 V−discharge start voltage Va=600 V=image-formation charge potential 600 V)), that is, prior to step S05 in FIG. 7.

Employing the cycle shutdown operation with the above-described sequence may eliminate the electrostatic charge of the image bearing member 21 to a target electric potential while suppressing toner fog and carrier transfer. By employing the two-stage static elimination process described above, the electric current flowing to the transfer unit 34 may be reduced, so that the transfer-unit power source 71 used may have a small current-carrying capacity, as compared with a case where the electrostatic charge of the image bearing member 21 is eliminated to a target electric potential at once in a single stage.

Alternatively, if the transfer-unit power source 71 has extra room in its current-carrying capacity, the electrostatic charge of the image bearing member 21 may be eliminated to a target electric potential at once in a single stage. In that case, for example, the first static-elimination rotation shown in FIG. 6 is omitted, and the voltage is changed at once to the voltage for the second static-elimination rotation from the start of the image forming process.

As another alternative, if the transfer-unit power source 71 has an even smaller current-carrying capacity, the static elimination may be performed gradually in three or more stages in a distributed manner. For example, in the case of three stages, the charging-unit output may be changed in the following order: 1200 V→1000 V→800 V→600 V, and the developing-unit output may be changed in the following order: 500 V→400 V→200 V→0 V. The transfer-unit output may be changed from 44 μA to a maximum electric current (e.g., 54 μA) for the current-carrying capacity, and this electric current may be maintained thereafter or may be changed in a stepwise fashion.

As an alternative to the above-described example in which the image forming apparatus 10 uses the intermediate transfer belt 30 shown in FIG. 1, for example, the exemplary embodiment of the present disclosure may be applied to a monochromatic image forming apparatus that does not use an intermediate transfer belt and that has only one image forming engine.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an image bearing member that has a toner image formed thereon while rotating and that retains the toner image until the toner image is transferred;
a charging unit that receives an image-formation charge voltage having a predetermined first polarity and used for electrostatically charging the image bearing member;
an exposure unit that radiates exposure light onto a region of the image bearing member so as to form an electrostatic latent image on the image bearing member, the region of the image bearing member receiving the image-formation charge voltage applied by the charging unit;
a developing unit that uses a toner to develop the electrostatic latent image formed on the image bearing member by the exposure unit;
a transfer unit that nips a transfer member by working together with the image bearing member and that receives a transfer voltage having a second polarity opposite to the first polarity between the transfer unit and the image bearing member so as to transfer the toner image formed on the image bearing member by the developing unit onto the transfer member; and
a controller that causes a transfer-unit static-elimination voltage to be applied to the transfer unit and causes a static-elimination charge voltage to be applied to the charging unit in an image-formation terminating sequence, the transfer-unit static-elimination voltage having the second polarity and having an absolute value larger than the transfer voltage, the static-elimination charge voltage having the first polarity and having an absolute value smaller than the image-formation charge voltage.

2. The image forming apparatus according to claim 1, wherein the charging unit receives the image-formation charge voltage that is constant-voltage-controlled and the static-elimination charge voltage that is constant-voltage-controlled and that has the absolute value smaller than the image-formation charge voltage, and
wherein the transfer unit applies a constant-current-controlled transfer current flowing in accordance with the application of the transfer voltage and a constant-current-controlled static-elimination current flowing in accordance with the application of the transfer-unit static-elimination voltage, the static-elimination current being larger than the transfer current.

3. The image forming apparatus according to claim 1,
wherein the transfer-unit static-elimination voltage applied to the transfer unit in the image-formation terminating sequence by the controller is a voltage that electrostatically charges the image bearing member to an excess static-elimination charge potential, the excess static-elimination charge potential being an electric potential exceeding a charge potential after static elimination according to the static-elimination charge voltage and having a polarity biased toward the second polarity or being an electric potential exceeding the charge potential after the static elimination and having the second polarity.

4. The image forming apparatus according to claim 2,
wherein the transfer-unit static-elimination voltage applied to the transfer unit in the image-formation terminating sequence by the controller is a voltage that electrostatically charges the image bearing member to an excess static-elimination charge potential, the excess static-elimination charge potential being an electric potential exceeding a charge potential after static elimination according to the static-elimination charge voltage and having a polarity biased toward the second polarity or being an electric potential exceeding the charge potential after the static elimination and having the second polarity.

5. The image forming apparatus according to claim 1,
wherein the transfer-unit static-elimination voltage applied to the transfer unit in the image-formation terminating sequence by the controller is a voltage that causes the image bearing member electrostatically charged to an image-formation charge potential as a result of applying the image-formation charge voltage to the charging unit to an excess static-elimination charge potential, the excess static-elimination charge potential being an electric potential having a polarity biased toward the second polarity or having the second polarity and further exceeding an ultimate charge potential in the image-formation terminating sequence, and
wherein the static-elimination charge voltage applied to the charging unit in the image-formation terminating sequence by the controller is a voltage that causes a charge potential of the image bearing member having transitioned to the excess static-elimination charge potential to transition to the ultimate charge potential in the image-formation terminating sequence.

6. The image forming apparatus according to claim 2,
wherein the transfer-unit static-elimination voltage applied to the transfer unit in the image-formation terminating sequence by the controller is a voltage that causes the image bearing member electrostatically charged to an image-formation charge potential as a result of applying the image-formation charge voltage to the charging unit to an excess static-elimination charge potential, the excess static-elimination charge potential being an electric potential having a polarity biased toward the second polarity or having the second polarity and further exceeding an ultimate charge potential in the image-formation terminating sequence, and
wherein the static-elimination charge voltage applied to the charging unit in the image-formation terminating sequence by the controller is a voltage that causes a charge potential of the image bearing member having transitioned to the excess static-elimination charge potential to transition to the ultimate charge potential in the image-formation terminating sequence.

7. The image forming apparatus according to claim 3,
wherein the transfer-unit static-elimination voltage applied to the transfer unit in the image-formation terminating sequence by the controller is a voltage that causes the image bearing member electrostatically charged to an image-formation charge potential as a result of applying the image-formation charge voltage to the charging unit to an excess static-elimination charge potential, the excess static-elimination charge potential being an electric potential having a polarity biased toward the second polarity or having the second polarity and further exceeding an ultimate charge potential in the image-formation terminating sequence, and
wherein the static-elimination charge voltage applied to the charging unit in the image-formation terminating sequence by the controller is a voltage that causes a charge potential of the image bearing member having transitioned to the excess static-elimination charge potential to transition to the ultimate charge potential in the image-formation terminating sequence.

8. The image forming apparatus according to claim 4,
wherein the transfer-unit static-elimination voltage applied to the transfer unit in the image-formation terminating sequence by the controller is a voltage that causes the image bearing member electrostatically charged to an image-formation charge potential as a result of applying the image-formation charge voltage to the charging unit to an excess static-elimination charge potential, the excess static-elimination charge potential being an electric potential having a polarity biased toward the second polarity or having the second polarity and further exceeding an ultimate charge potential in the image-formation terminating sequence, and
wherein the static-elimination charge voltage applied to the charging unit in the image-formation terminating sequence by the controller is a voltage that causes a charge potential of the image bearing member having transitioned to the excess static-elimination charge potential to transition to the ultimate charge potential in the image-formation terminating sequence.

9. The image forming apparatus according to claim 1,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

10. The image forming apparatus according to claim 2,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

11. The image forming apparatus according to claim 3,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

12. The image forming apparatus according to claim 4,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

13. The image forming apparatus according to claim 5,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

14. The image forming apparatus according to claim 6,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

15. The image forming apparatus according to claim 7,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

16. The image forming apparatus according to claim 8,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the controller changes a voltage applied to the developing roller to a static-elimination development voltage having the first polarity and having an absolute value smaller than the image-formation development voltage at a point when a region of the image bearing member reaches a position where the image bearing member receives an effect of the developing unit in accordance with rotation of the image bearing member in the image-formation terminating sequence, the region being located where the image bearing member receives an effect of the charging unit when the static-elimination charge voltage is applied to the charging unit.

17. The image forming apparatus according to claim 1,
wherein the image-formation terminating sequence executed by the controller includes a sequence involving applying a first static-elimination charge voltage for electrostatically charging the image bearing member to a first static-elimination charge potential to the charging unit, electrostatically charging an entire periphery of the image bearing member to the first static-elimination charge potential, and applying a second static-elimination charge voltage to the charging unit, the first static-elimination charge potential having an absolute value smaller than an image-formation charge potential according to the image-formation charge voltage applied to the charging unit and larger than a charge potential at an end of the image-formation terminating sequence, the second static-elimination charge voltage being for electrostatically charging the image bearing member to a second static-elimination charge potential having an absolute value equal to an ultimate charge potential at the end of the image-formation terminating sequence or larger than the ultimate charge potential.

18. The image forming apparatus according to claim 2,
wherein the image-formation terminating sequence executed by the controller includes a sequence involving applying a first static-elimination charge voltage for electrostatically charging the image bearing member to a first static-elimination charge potential to the charging unit, electrostatically charging an entire periphery of the image bearing member to the first static-elimination charge potential, and applying a second static-elimination charge voltage to the charging unit, the first static-elimination charge potential having an absolute value smaller than an image-formation charge potential according to the image-formation charge voltage applied to the charging unit and larger than a charge potential at an end of the image-formation terminating sequence, the second static-elimination charge voltage being for electrostatically charging the image bearing member to a second static-elimination charge potential having an absolute value equal to an ultimate charge potential at the end of the image-formation terminating sequence or larger than the ultimate charge potential.

19. The image forming apparatus according to claim 17,
wherein the developing unit includes a developing roller that receives an image-formation development voltage having the first polarity and having an absolute value smaller than an image-formation charge potential of the image bearing member electrostatically charged as a result of applying the image-formation charge voltage to the charging unit, the developing roller rotating and transporting a developer containing a toner and a carrier to a developing region facing the image bearing member, and
wherein the image-formation terminating sequence executed by the controller includes a sequence involving changing a voltage applied to the developing roller to a first static-elimination development voltage at a point when a first region of the image bearing member reaches a position where the image bearing member receives an effect of the developing unit in accordance with rotation of the image bearing member, and changing the voltage applied to the developing roller to a second static-elimination development voltage at a point when a second region of the image bearing member reaches a position where the image bearing member receives an effect of the developing unit in accordance with rotation of the image bearing member, the first static-elimination development voltage having an absolute value smaller than the image-formation development voltage and larger than an applied voltage at an end of the image-formation terminating sequence, the first region being located where the image bearing member receives an effect of the charging unit when the first static-elimination charge voltage is applied to the charging unit, the second static-elimination development voltage having an absolute value smaller than the first static-elimination development voltage, the second region being located where the image bearing member receives an effect of the charging unit when the second static-elimination charge voltage is applied to the charging unit.

20. The image forming apparatus according to claim 1,
wherein the controller stops a developing roller included in the developing unit to stop rotating no later than or during a period in which a region of the image bearing member that receives an effect of the developing unit is within a region affected by the image-formation charge voltage applied to the charging unit in the image-formation terminating sequence.
